(19) United States
(12) Patent Application Publication
(10) Pub. No.: US 2006/0253480 A1
(43) Pub. Date: Nov. 9, 2006

(54) Collaborative design process for a design team, outside suppliers, and outside manufacturers

(76) Inventor: Peter Ethan Staples, Los Angeles, CA (US)

Correspondence Address: SCHOX PLC, 209 N. MAIN STREET #200, ANN ARBOR, MI, 48104, US

(21) Appl. No.: 11/430,707

(22) Filed: May 8, 2006

Related U.S. Application Data
(63) Continuation-in-part of application No. 10/118,118, filed on Apr. 6, 2002, now abandoned.

(51) Int. Cl. G06F 17/00

(52) U.S. Cl. 707/100

(57) ABSTRACT

In a first embodiment, the invention includes a collaborative design process for a design team that generates an incomplete design for a project, outside suppliers that supply components for the project, and outside manufacturers that manufacturer the complete design for the project. The process includes storing an incomplete design generated by the design team within a secure network; providing access to the incomplete design over the secure network and facilitating comments from outside suppliers on the incomplete design; storing a complete design generated by the design team within the secure network; providing access to the complete design to the outside manufacturers over the secure network; and facilitating use of the complete design by at least one of the outside manufacturers. In a second embodiment, the invention includes a method of managing several collaborative design processes within the same secure network.

### CROSS-REFERENCE TO RELATED APPLICATIONS

This application is a continuation-in-part of prior application Ser. No. 10/118,118 entitled “Management of collaborative design process” and filed 06 Apr. 2002, which is incorporated in its entirety by this reference.

### BACKGROUND

The Internet has proven to be a valuable tool for sharing design information between interested parties. Presently, the sharing of design information generally takes the form of transferring files, similar to a note or a letter, from one party to another. Existing methods allow for exchanging completed designs, similar to a brochure, between parties or incorporating one completed design into a lager, more complex design. There are no current tools or methods, however, to provide a way for various parties to access an incomplete design, i.e., a whiteboard for a design that has not been fully developed to perform its intended function. Often there are parties that have a vested interest in making the design successful even though they are not actually responsible for the design itself. Examples of these interested parties are contract manufacturers and component suppliers. These parties are generally excluded from the design process until a design is completed. Their participation has the potential to enhance the design and speed up product development.

### SUMMARY

In one embodiment, the invention includes a collaborative design process for a design team that generates an incomplete design for a project, outside suppliers that supply components for the project, and outside manufacturers that manufacturer the complete design for the project. The process includes storing an incomplete design generated by the design team within a secure network; providing access to the incomplete design over the secure network and facilitating comments from outside suppliers on the incomplete design; storing a complete design generated by the design team within the secure network; providing access to the complete design to the outside manufacturers over the secure network; and facilitating use of the complete design by at least one of the outside manufacturers. As used throughout this document, the phrase “incomplete design” refers to a design that has not been fully developed to perform its intended function.

In another embodiment, the collaborative design process also includes presenting terms of an intellectual property agreement to the outside suppliers and, only upon acceptance of the terms, providing access to the incomplete design over the secure network. Similarly, the process may include, presenting terms of an intellectual property agreement to the outside manufacturers and, only upon acceptance of the terms, providing access to the complete design over the secure network.

The collaborative design process may also include facilitating comments from the first outside supplier on the incomplete design. The collaborative design process may also include facilitating use of the complete design by at least one of the outside manufacturers and, upon use of the complete design by one of the outside manufacturers, receiving payment from the outside manufacturer.

In another aspect, the invention includes a method of managing several collaborative design processes, as described above, within the same secure network. In this aspect, the outside suppliers have access to more than one of the incomplete designs and the outside manufacturers have access to more than one of the complete designs.

The aspects of the invention may have one or more of the following advantages. The invention may allow outside parties to witness the design in an incomplete stage; identify the engineers who are responsible for the specific portions of the design; automate the process of granting access to proprietary information; and include payment mechanisms for manufacturers' use of design information. Other features, objects, and advantages of the invention will be apparent from the description the drawings, and the claims.

### BRIEF DESCRIPTION OF THE DRAWINGS

FIG. 1 is a schematic diagram of the basic components of the design management process according to the embodiments of the invention.

FIG. 2 is a flowchart of the membership module

FIGS. 3 and 4 are an example of a website layout and a matrix, respectively, used in the design management module.

Like reference symbols in the various drawings indicate like elements.

### DETAILED DESCRIPTION OF THE EMBODIMENTS

The following description of the preferred embodiments of the invention is not intended to limit the invention to these preferred embodiments, but rather to enable any person skilled in the art to make and use this invention.

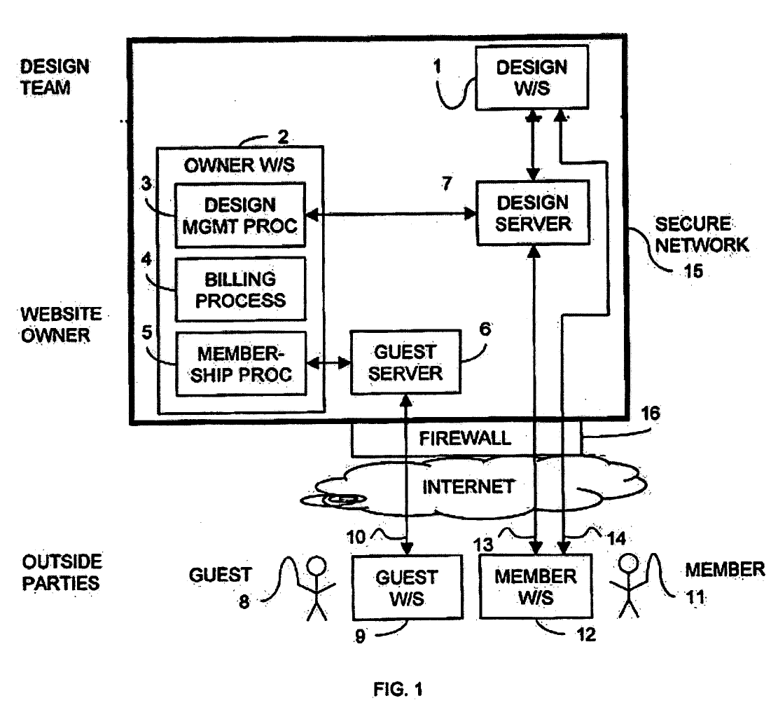

As shown in FIG. 1, the invention relates to the exchange of information between three groups: a design team, a design facilitator, and outside parties including outside guests and outside members. The design team works on a collection of one or more processors (e.g. workstations) including a design workstation 1. The design facilitator controls one or more workstations, including design facilitator workstation 2 and two or more data servers, including servers 6 and 7. The data servers 6 and 7 are workstations specially designed to disseminate files (such as hypertext markup language, also known as “HTML”, webpages) to other workstations. Outside parties include guests (such as a guest 8) and members (such as a member 11), each with a workstation (workstations 9 and 12 respectively).

The design workstation 1 is connected to the design server 7 and, via this connection, the design team may upload design information from the design workstation 1 to the design server 7. The design facilitator workstation 2 preferably runs three modules: a membership module 5, a design management module 3, and a billing module 4. The design management module 3 and the billing module 4 are connected to the design server 7. The membership module 5 is connected to the guest server 6.

The design team and the design facilitator are preferably part of a secure network 15 and are preferably behind a firewall 16. The firewall 16 is preferably implemented as software running on a standalone computer or running simultaneously on servers 6 and 7 and design workstation 1. The secure network 15 and the firewall 16 function to prevent unauthorized access of the design information in the secure network 15. Any outside party attempting to access the secure network 15 will encounter the firewall 16. An outside party is either a guest 8 or a member 11. If the outside party is a member, a member identification and password are entered and the firewall 16 makes a query to a database (not pictured) to determine whether the outside party is indeed a member. If membership is confirmed, member 11 can use a workstation 12 to access the design server 7 via a connection 13 through the firewall 16. If membership cannot be confirmed, the outside party is classified as a guest. A guest 8 only has access to guest server 6. Using a workstation 9, the guest 8 accesses the guest server 6 via a connection 10 through the firewall 16. The member workstation 12 is also connected to design workstation 1 for the purpose of sending direct feedback to the design team. This connection 14 is also through the firewall 16. Although the embodiment in FIG. 1 has two distinct links 13 and 14 between member workstation 12 and design workstation 1, in some scenarios member workstation 12 can communicate with design workstation 1 via design server 7 and connection 13.

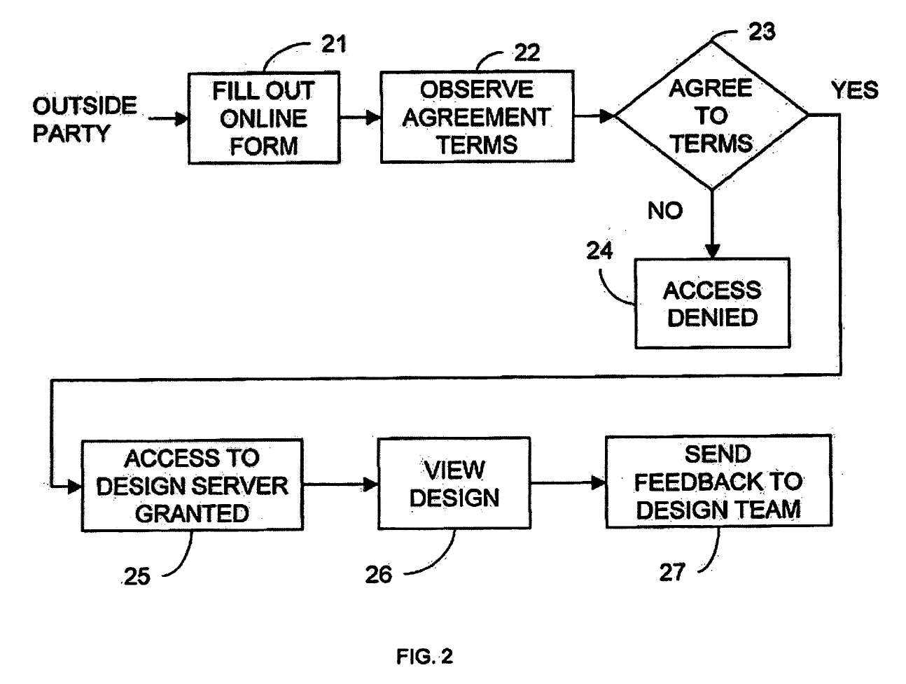

As shown in FIG. 2, the membership module 5 may include several steps. Any guest may become a member via the membership module 5. This module requires the exchange of data between the guest workstation 9, the membership module 5 (running on the design facilitator workstation 2), and the guest server 6. First, the guest 8 (i.e., the outside party in FIG. 2) contacts the guest server 6 and provides contact information via an online form (step 21). The guest 8 views an agreement sent by the guest server 6 on the guest workstation 9 (step 22). The agreement defines the terms, set by the design facilitator or the design team, for viewing the designs. When the guest 8 acknowledges these terms (step 23), he becomes a member and gains access to the design server 7 (step 25). The guest 8 may then view the designs (step 26). The agreements are archived in the design facilitator workstation 2 (as shown in FIG. 1) or in a separate database within the secure network 15. If the guest 8 does not agree to the terms (step 23), he remains a guest and is denied access to design server 7 (step 24). Design information on the design server 7 includes contact information for the engineers on the design team. The member 11 may contact the design team directly to ask questions or provide comments about the design (step 27).

Design information is made available on files, such as webpages, stored on the design server 7. An engineering authority for the overall design is identified on such files. An example of this identification is a hyperlink label. A hyperlink is an electronic link providing direct access from one distinctly marked place on a webpage. An engineering authority is also identified for each component of the design. Alternatives for various design parameters are also displayed on a webpage. The design parameters are shown as options under consideration for each of the components. The engineering authority is the person responsible for selecting the best option for the component. Members who view the design can contact the engineering authority of the overall design or of specific components via the appropriate hyperlink. This is an example of how the engineers receive feedback on the design. If the member 11 happens to be a supplier of a component in the design, he is motivated to provide updated information on that component to the relevant engineering authority.

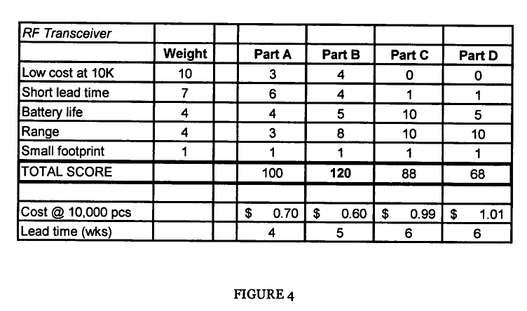

In one variation, suppliers may provide data to the design team that corresponds to the component that they supply. After receiving this data, the engineering authority may review the data, rate the particular component supplied by the supplier, and then create a matrix, as shown in FIG. 4, to be stored on the secure network. The parameters could include, for example, price, low power consumption, transmission range, and maturity of the design tools. Based on the product's requirements the design team would assign a weight for each parameter to set its importance to the decision. The component supplied by the supplier with the highest rating is chosen for the complete design. The engineering authority in charge of the decision would then post the matrix and the complete design on the secure network for comment. The member suppliers may access this matrix, which includes the parameters for a particular component and the ratings of the components that are supplied by the suppliers. Naturally, suppliers would want to submit their comments about why their component should be rated more favorably than the others. They might send samples, datasheets, test data, and referrals to the engineering authority to help make their case. Although not a required feature, the supplier may be asked to pay for the rating or review of their component. This may help prevent the design team from getting overwhelmed with choices from suppliers. This may also help distinguish the serious suppliers from the non-serious suppliers. As envisioned, at least a portion of this payment would be transferred to the design team in compensation for their rating or review of the component of the supplier.

In another variation, the suppliers may provide the price and lead times to the design team that corresponds to the component that they supply. This price and lead times data may be stored with the complete design on the secure network. Manufacturers that access the complete design will be able to see the exact Bill of Materials (“BOM”) for the complete design, including the price and lead times for every component. To prevent any “bait and switch” scenarios, the suppliers that provide a price and lead time will be obligated to supply the particular components at that price and on those terms to any manufacturer that licenses, purchases, or otherwise lawfully uses the complete design. This obligation may be in the form of an online agreement, a verification or authentication of the supplier, or any other suitable method.

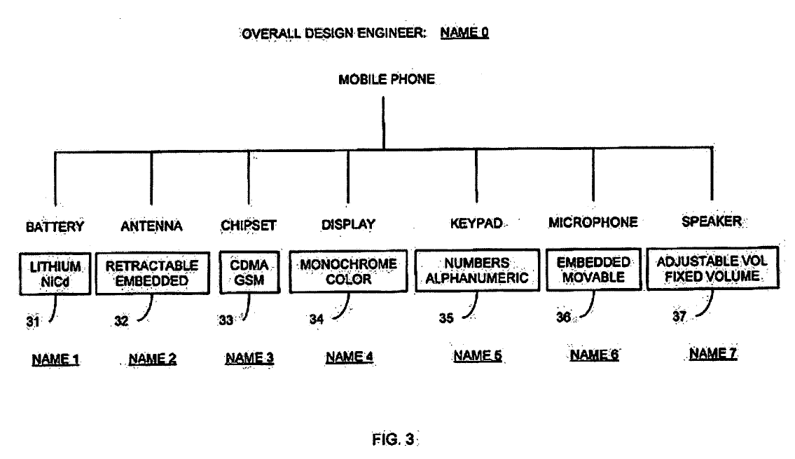

As shown in FIG. 3, an embodiment of the design management process may be implemented for designing a mobile telephone. A mobile telephone has several essential components such as a battery 31, an antenna 32, a chipset 33, a display 34, a keypad 35, a microphone 36, and a speaker 37. For each component, multiple options may exist. As part of the design method, one of the files stored on the design server 7 displays—preferably for each component—the component name, the list of parameters and options under consideration, and an engineering authority (i.e., NAME 1-NAME 7) responsible for selecting the best option. This file is made available to everyone who has completed the membership module 5. Two options are listed under battery 31: lithium and nickel cadmium. If a maker of lithium batteries is a member and observes the file, he may see who is responsible (i.e., NAME 1) for deciding on the battery used in the mobile phone design. Thus, the battery maker may have a direct means of contacting this engineer. The battery maker may be able to alert the engineer to new product offerings, test results, pricing information, or other information relating to the completion of the design. When this information is combined with similar data from competing battery vendors, the engineer is in a better position to select the optimal design. In addition to component suppliers, manufacturers are an important group of members. Manufacturers of the final product (e.g., mobile telephones in this case) may be able to provide useful insight to the costs of integrating and producing the device. This information may be valuable to the design team and the owner since they ultimately want manufacturers to use the design, make the product, and pay royalties. A mobile phone is, of course, just one possible design. Design management process 3 may be applied, either consecutively or simultaneously, to numerous other projects including, but not limited to, integrated circuits, heavy equipment, and medical devices.

Manufacturers are the customers of the completed design of the design management process 3 since they pay royalties for using the completed designs. The manufacturers are likely to access the secure network and view the files repeatedly for the purpose of planning production runs and perhaps influencing the design to make it more suitable to their manufacturing methods. Manufacturers who use the completed design pay a predetermined royalty to the design facilitator and/or the design team. The use of the complete design may be an exclusive use (i.e., one manufacturer licenses or purchases the exclusive right to use the complete design) or a non-exclusive use (i.e., multiple manufacturers license or purchase the right to use the same complete design). The amount of the payment is computed as part of the billing module 4. The billing module 4 requires the interaction between the member workstation 12, the design server 7, and the owner workstation 2. An example of this interaction is described below.

In one variation, the royalty may be set at a particular amount (e.g., $0.50 per unit produced). The number of units produced by the manufacturer (e.g., 100,000) is measured and recorded on the member workstation 12. This information is sent from the member workstation 12 to the billing module 4 via the design server 7. The billing module 4 takes the number of units produced (100,000) and the royalty ($0.50 per unit produced) and computes a payment ($50,000) payable by the manufacturer to the design facilitator.

As a person skilled in the art will recognize from the previous detailed description and from the figures and claims, modifications and changes can be made to the preferred embodiments of the invention without departing from the scope of this invention defined in the following claims.

I claim:

1. A collaborative design process for a design team that generates an incomplete design for a project, outside suppliers that supply components for the project, and outside manufacturers that manufacturer the complete design for the project, comprising the steps of:
storing an incomplete design generated by the design team within a secure network;
upon the request of a first outside supplier, presenting terms of an intellectual property agreement to the first outside supplier and, upon acceptance of the terms by the first outside supplier, providing access to the incomplete design over the secure network and facilitating comments from the first outside supplier on the incomplete design;
upon the request of a second outside supplier, presenting terms of an intellectual property agreement to the second outside supplier and, upon acceptance of the terms by the second outside supplier, providing access to the incomplete design over the secure network and facilitating comments from the second outside supplier on the incomplete design;
storing a complete design generated by the design team within the secure network;
upon the request by a first outside manufacturer, presenting terms of an intellectual property agreement to the first outside manufacturer and, upon acceptance of the terms by the first outside manufacturer, providing access to the complete design over the secure network;
upon the request by a second outside manufacturer, presenting terms of an intellectual property agreement to the second outside manufacturer and, upon acceptance of the terms by the second outside manufacturer, providing access to the complete design over the secure network; and
facilitating use of the complete design by at least one of the outside manufacturers and, upon use of the complete design by one of the outside manufacturers, receiving payment from the outside manufacturer.

2. The collaborative design process of claim 1, wherein the step of storing an incomplete design generated by the design team also includes storing information that identifies multiple components of the incomplete design.

3. The collaborative design process of claim 2, wherein the step of storing information also includes storing an engineering authority for each component and contact information for each engineering authority.

4. The collaborative design process of claim 3, wherein the step of providing access to the incomplete design over the secure network and facilitating comments from the first outside supplier on the incomplete design also includes providing access to at least one of the engineering authorities of the incomplete design over the secure network and facilitating communication between the first outside supplier and the at least one engineering authority.

5. The collaborative design process of claim 2, wherein the step of storing an incomplete design generated by the design team also includes storing parameters for a particular component.

6. The collaborative design process of claim 5, further comprising:
receiving data corresponding to the parameters of the particular component supplied by the first outside supplier;
receiving data corresponding to the parameters of the particular component supplied by the second outside supplier; and
providing the data corresponding to the parameters of the particular component supplied by the outside suppliers to the design team.

7. The collaborative design process of claim 6, further comprising storing a matrix for the particular component within the secure network and providing access to the matrix to the first outside supplier and to the second outside supplier over the secure network.

8. The collaborative design process of claim 7, wherein the matrix includes the parameters for the particular component, the data corresponding to the parameters of the particular component supplied by the first outside supplier, and the data corresponding to the parameters of the particular component supplied by the second outside supplier.

9. The collaborative design process of claim 8, wherein the matrix further includes a rating of the particular component supplied by the first outside supplier and a rating of the particular component supplied by the second outside supplier.

10. The collaborative design process of claim 9, further comprising:
receiving payment from the first outside supplier and transferring at least a portion of this payment to the design team in compensation for the rating of the particular component supplied by the first outside supplier.

11. The collaborative design process of claim 6, further comprising the steps of:
receiving data corresponding to the price of the particular component supplied by the first outside supplier; and
receiving data corresponding to the price of the particular component supplied by the second outside supplier.

12. The collaborative design process of claim 11, wherein the step of storing a complete design generated by the design team includes the identification of one of the outside suppliers and the price corresponding to the particular component and the identified outside supplier.

13. The collaborative design process of claim 12, further comprising
upon use of the complete design by one of the outside manufacturers, obligating the identified outside supplier to supply the particular component for the price corresponding to the particular component and the identified outside supplier.

14. The collaborative design process of claim 1, further comprising the steps of:
facilitating use of the complete design by the first outside manufacturer and, upon use of the complete design by the first outside manufacturer, receiving payment from the first outside manufacturer; and
facilitating use of the complete design by the second outside manufacturer and, upon use of the complete design by the second outside manufacturer, receiving payment from the second outside manufacturer.

15. A method of managing several collaborative design processes that each involves a design team that generates an incomplete design for a project, outside suppliers that supply components for the project, and outside manufacturers that manufacturer the complete design for the project, comprising the steps of:
storing a first incomplete design generated by a first design team within a secure network and storing a second incomplete design generated by a second design team within the secure network;
upon the request of a first outside supplier, presenting terms of an intellectual property agreement to the first outside supplier and, upon acceptance of the terms by the first outside supplier, providing access to the incomplete designs over the secure network and facilitating comments from the first outside supplier on the incomplete designs;
upon the request of a second outside supplier, presenting terms of an intellectual property agreement to the second outside supplier and, upon acceptance of the terms by the second outside supplier, providing access to the incomplete designs over the secure network and facilitating comments from the second outside supplier on the incomplete designs;
storing a first complete design generated by the first design team within the secure network and storing a second complete design generated by the second design team within the secure network;
upon the request by a first outside manufacturer, presenting terms of an intellectual property agreement to the first outside manufacturer and, upon acceptance of the terms by the first outside manufacturer, providing access to the complete designs over the secure network;
upon the request by a second outside manufacturer, presenting terms of an intellectual property agreement to the second outside manufacturer and, upon acceptance of the terms by the second outside manufacturer, providing access to the complete designs over the secure network; and
facilitating use of at least one of the complete designs by at least one of the outside manufacturers and, upon use of at least one of the complete designs by one of the outside manufacturers, receiving payment from the outside manufacturer.

16. The collaborative design process of claim 15, wherein the step of storing a first incomplete design also includes storing information that identifies multiple components of the first incomplete design and storing parameters for a particular component.

17. The collaborative design process of claim 16, further comprising:
receiving data corresponding to the parameters of the particular component supplied by the first outside supplier;
receiving data corresponding to the parameters of the particular component supplied by the second outside supplier; and
providing the data corresponding to the parameters of the particular component supplied by the outside suppliers to the first design team.

18. The collaborative design process of claim 17, further comprising storing a matrix for the particular component within the secure network and providing access to the matrix to the first outside supplier and to the second outside supplier over the secure network, wherein the matrix includes the parameters for the particular component, the data corresponding to the parameters of the particular component supplied by the first outside supplier, and the data corresponding to the parameters of the particular component supplied by the second outside supplier.

19. The collaborative design process of claim 18, wherein the matrix further includes a rating of the particular component supplied by the first outside supplier and a rating of the particular component supplied by the second outside supplier.

20. The collaborative design process of claim 19, further comprising:
receiving payment from the first outside supplier and transferring at least a portion of this payment to the first design team in compensation for the rating of the particular component supplied by the first outside supplier.
